(19) United States
(12) Patent Application Publication
(10) Pub. No.: US 2007/0142101 A1
(43) Pub. Date: Jun. 21, 2007

(54) Mobile electronic device having a rotatable keypad

(76) Inventors: Sudhir Seshagiri, Hainesville, IL (US); Roger W. Harmon, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 11/209,327

(22) Filed: Aug. 23, 2005

(51) Int. Cl. H04M 1/00

(52) U.S. Cl. 455/575.4

(57) ABSTRACT

A mobile electronic device (100), suitable for operation in a first configuration and a second configuration, includes a first housing (102) and a second housing (104) coupled to the first housing. The second housing includes a rotatable keypad (202). The rotatable keypad rotates when the first housing (102) and the second housing (104) are changed from a first configuration to a second configuration.

### FIELD OF THE INVENTION

This invention relates in general to mobile electronic devices, and more specifically to slide mechanisms in mobile electronic devices.

### BACKGROUND OF THE INVENTION

Due to growth in modem communication technology, a large number of mobile electronic devices such as mobile phones, pagers, personal digital assistants, and the like have been introduced in the market. In order to keep up with this trend and to gain a competitive advantage, manufacturers of communication devices focus on enhancing the functionalities of mobile electronic devices, and at the same time making them compact. However, the small size of mobile electronic devices reduces the area available for keys and displays on the devices. To counter this restriction caused by reduced size, mobile electronic devices with multiple housings have been developed, which can be folded or otherwise compacted when they are not in use.

Some foldable mobile electronic devices have two or more housings. However, mobile electronic devices with multiple housings suffer from one or more of the following limitations. First, multiple housings increase the weight of the mobile electronic device. Second, multiple housings increase the thickness of the mobile electronic devices. Third, while typing text with alphanumeric characters, the mobile electronic device needs to be switched to different modes to alternatively enter characters from a telephonic keypad or a QWERTY keypad.

### BRIEF DESCRIPTION OF THE DRAWINGS

The present invention is illustrated by way of example and not limitation in the accompanying figures, in which like references indicate similar elements, and in which:

FIG. 1 shows a view of an exemplary mobile electronic device in a normal configuration, in accordance with a basic embodiment.

FIG. 2 shows a view of the mobile electronic device of FIG. 1 in a first configuration, in accordance with the basic embodiment.

FIG. 3 shows a view of the mobile electronic device of FIG. 1 in a second configuration, in accordance with the basic embodiment.

FIG. 4 shows a section view of an exemplary mobile electronic device in a normal configuration, illustrating rotation of a rotatable keypad using a slot, in accordance with a first detailed embodiment.

FIG. 5 shows a section view of the mobile electronic device of FIG. 4 in a first configuration, illustrating rotation of the rotatable keypad using the slot, in accordance with the first detailed embodiment.

FIG. 6 shows a section view of the mobile electronic device of FIG. 4 in a second configuration, illustrating rotation of the rotatable keypad using the slot, in accordance with the first detailed embodiment.

FIG. 7 shows a rear view of the first housing of the mobile electronic device of FIG. 4, in accordance with the first detailed embodiment.

FIG. 8 shows a section view of the mobile electronic device of FIG. 4 in the normal configuration, illustrating a dual slide mechanism and a flexible circuit, in accordance with the first detailed embodiment.

FIG. 9 shows a section view of the mobile electronic device of FIG. 4 in the first configuration illustrating the dual slide mechanism and the flexible circuit, in accordance with the first detailed embodiment.

FIG. 10 shows a section view of the mobile electronic device of FIG. 4 in the second configuration illustrating the dual slide mechanism and the flexible circuit, in accordance with the first detailed embodiment.

FIG. 11 shows a section view of an exemplary mobile electronic device in a normal configuration, illustrating rotation of the rotatable keypad using a link mechanism, in accordance with a second detailed embodiment.

FIG. 12 shows a section view of the mobile electronic device of FIG. 11 in a first configuration, illustrating rotation of the rotatable keypad using the link mechanism, in accordance with the second detailed embodiment.

FIG. 13 shows a section view of the mobile electronic device of FIG. 11 in a second configuration, illustrating rotation of the rotatable keypad using the link mechanism, in accordance with the second detailed embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Before describing in detail the particular mobile electronic device in accordance with the present invention, it should be observed that the present invention resides primarily in apparatus components related to the mobile electronic device. Accordingly, the apparatus components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

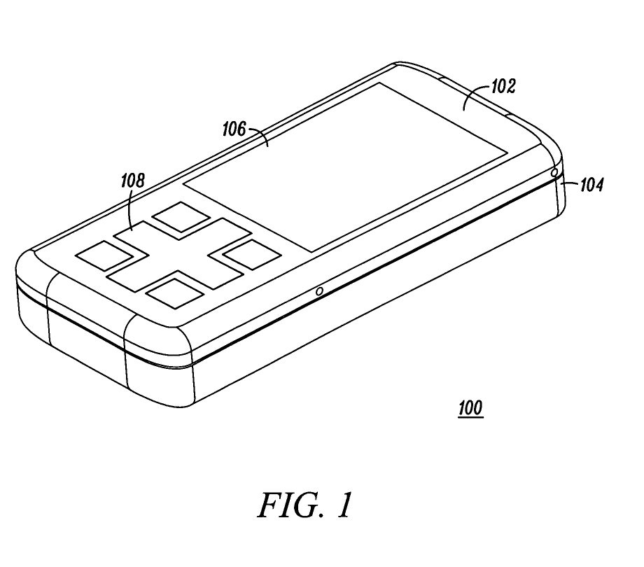

FIG. 1 shows a view of an exemplary mobile electronic device 100 in a normal configuration, in accordance with a basic embodiment. Examples of the mobile electronic device 100 include devices such as mobile phones, pagers, remote controllers, and personal digital assistants (PDAs). The mobile electronic device 100 includes a first housing 102 and a second housing 104. The first housing 102 includes a display unit 106 and external keys 108. The external keys 108 shown are navigational keys and soft keys, although they may be easily substituted by other keys such as power on/off, volume up/down, display on/off, and display contrast up/down. Further, external keys may be implemented virtually using a touch screen, a touchpad, a joystick or other input mechanism.

The mobile electronic device 100 is suitable for operation in the normal configuration and also in a first configuration and a second configuration. The normal configuration is considered a most compact configuration of the multi-housing mobile electronic device. The normal configuration, the first configuration, and the second configuration are defined based on the relative positions of the first housing 102 and the second housing 104. In accordance with an embodiment, the normal configuration, the first configuration, and the second configuration affect on the usability of a rotatable keypad and a set of keys on the second housing 104.

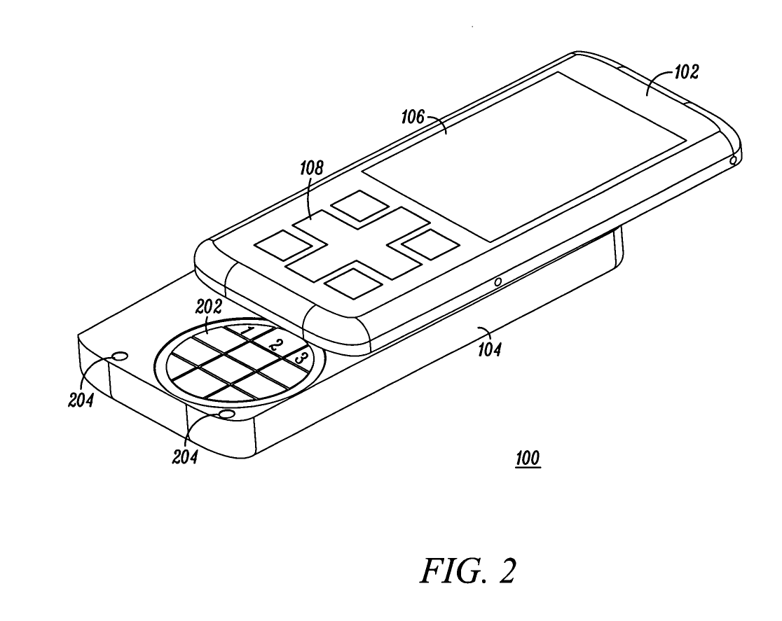

FIG. 2 shows a view of the mobile electronic device 100 of FIG. 1 in the first configuration, in accordance with the basic embodiment. In the first configuration, the first housing 102 and the second housing 104 are offset to each other relative to the normal configuration but remain aligned with each other along one dimension, in this case along the lengths. The first configuration reveals that the second housing 104 includes a rotatable keypad 202 and one or more magnets 204. The one or magnets 204 provide a detent between the normal configuration and the first and the second configurations to reduce accidental switching between configurations. If implemented as Hall effect sensors, the one or more magnets 204 also sense the configuration of the mobile electronic device 100 and switch the display 106 from portrait to landscape and back depending on the configuration of the mobile electronic device 100. The one or more magnets 204 could be placed in alternate locations such as along the top edge of the second housing 104 or in the first housing 102 or in both the first housing 102 and the second housing 104. The rotatable keypad 202 may be implemented as a standard 12-key telephonic number keypad. The mobile electronic device 100 can be operated in the first configuration using the rotatable keypad 202 and the external keys 108.

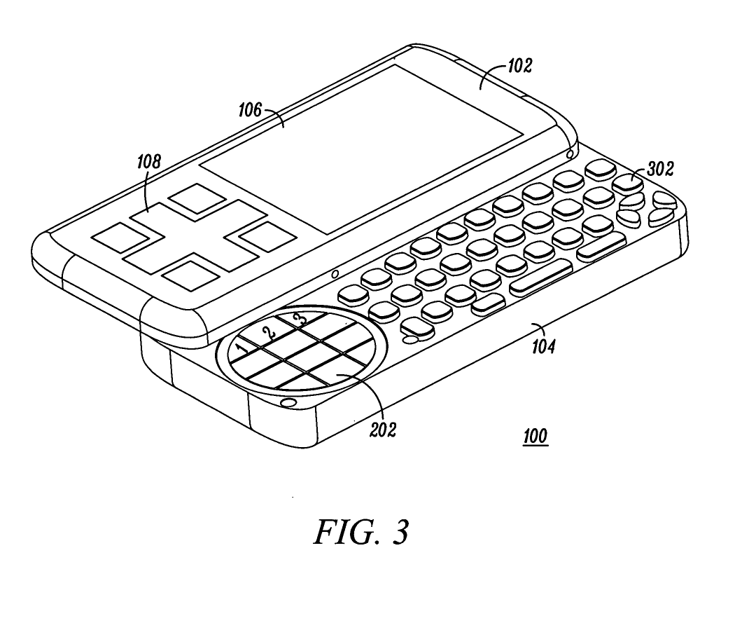

FIG. 3 shows a view of the mobile electronic device 100 of FIG. 1 in the second configuration, in accordance with the basic embodiment. In the second configuration, the first housing 102, and the second housing 104 are offset to each other relative to the normal configuration but remain aligned with each other along another dimension, in this case along the widths. The second configuration reveals that the second housing 104 further includes a set of internal keys 302. In accordance with an embodiment, the set of internal keys 302 form a QWERTY alphabet keypad. The mobile electronic device 100 is operated in the second configuration by using the external keys 108, the rotatable keypad 202, and the set of internal keys 302.

As shown in FIG. 2 and FIG. 3, when the mobile electronic device 100 is switched from the first configuration to the second configuration, the rotatable keypad 202 rotates by an angle of 90 degrees in the counterclockwise direction, and vice versa. The display on the display unit 106 also shifts orientation from portrait to landscape when the mobile electronic device 100 is switched from the first configuration to the second configuration and vice versa.

In the first configuration, only the rotatable keypad 202 is visible and the set of internal keys 302 is hidden. In the second configuration, the rotatable keypad 202 and the set of internal keys 302 are both visible. In the normal configuration, both the rotatable keypad 202 and the set of internal keys 302 are hidden.

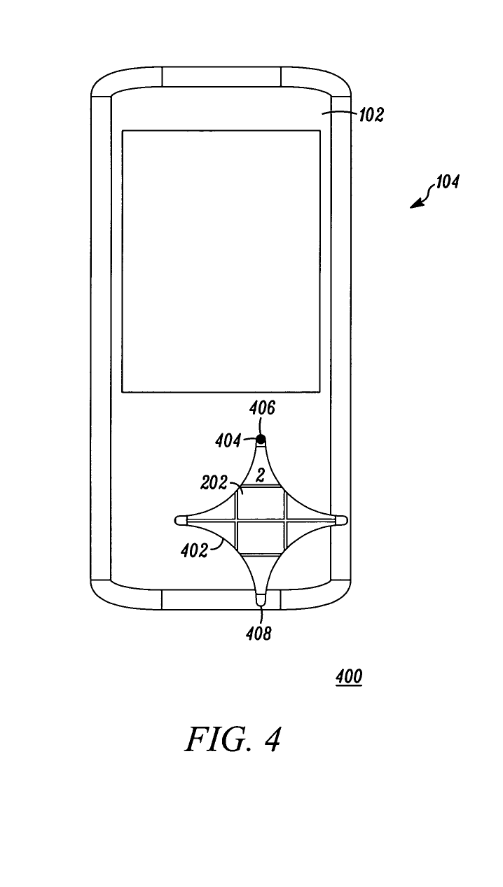

FIG. 4 shows a section view of an exemplary mobile electronic device 400 in a normal configuration, illustrating rotation of the rotatable keypad 202 using a slot 402, in accordance with a first detailed embodiment. The first housing 102 includes the slot 402 on a bottom surface close to the rotatable keypad 202 in the second housing 104. In accordance with an embodiment, the slot 402 is a star-shaped pocket. a first pin 404 coupled to the rotatable keypad 202 moves inside the slot 402. In FIG. 4, the first pin 404 is located at a first position 406 in the slot 402. The slot 402 guides the first pin 404 when the mobile electronic device 400 is switched from the first configuration to the second configuration, and from the second configuration to the first configuration. In accordance with an embodiment, the first pin 404 moves from the first position 406 to a second position 408 when the mobile electronic device 100 is switched from the normal configuration to the first configuration.

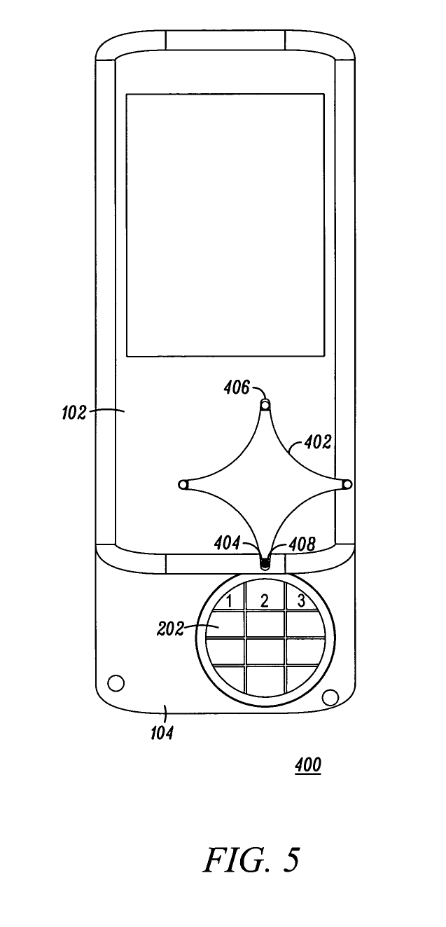

FIG. 5 shows a section view of the mobile electronic device 400 of FIG. 4 in a first configuration, illustrating rotation of the rotatable keypad 202 using the slot 402, in accordance with the first detailed embodiment. When the mobile electronic device 100 is switched from the normal configuration (as illustrated in FIG. 4) to the first configuration (as illustrated in FIG. 5), the first pin 404 moves relative to the slot 402, from the first position 406 to the second position 408 in the slot 402.

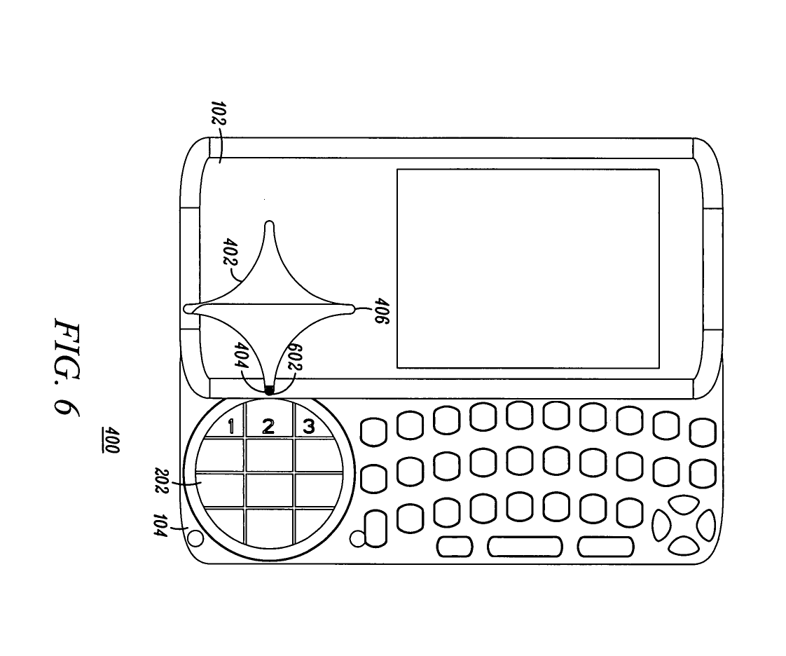

FIG. 6 shows a section view of the mobile electronic device 400 of FIG. 4 in a second configuration, illustrating the rotation of the rotatable keypad 202 using the slot 402, in accordance with the first detailed embodiment. When the mobile electronic device 400 is switched from the normal configuration (as illustrated in FIG. 4) to the second configuration (as illustrated in FIG. 6), the first pin 404 moves inside the slot 402 from the first position 406 to a third position 602 in the slot 402. The change in the position of the first pin 404, which is coupled to the rotatable keypad 202, results in the rotation of the rotatable keypad 202 when the mobile electronic device 100 is switched from the normal configuration to the second configuration, and from the second configuration to the normal configuration. In accordance with an embodiment, the mobile electronic device 100 switches from the first configuration to the second configuration (and from the second configuration to the first configuration) via the normal configuration.

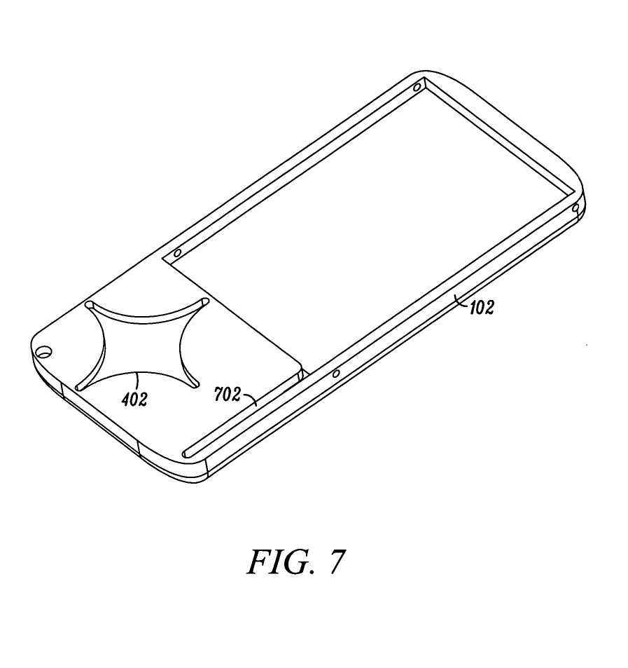

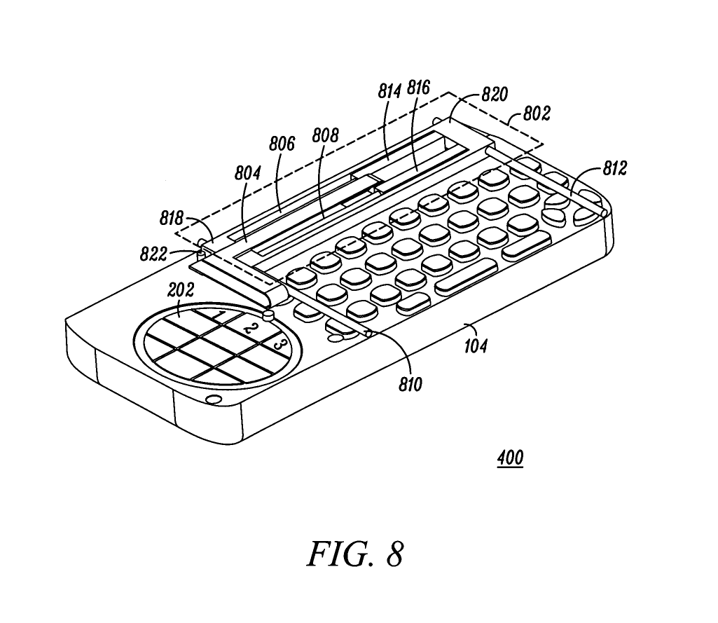

FIG. 7 shows a rear view of the first housing 102 of the mobile electronic device 400 of FIG. 4, in accordance with the first detailed embodiment. The slot 402 is present on the bottom surface of the first housing 102. The first housing 102 includes a groove 702, aligned along a dimension, in this case along the length. The second housing 104 includes a second pin 822 (shown in FIG. 8). The second pin 822 moves in the groove 702 and prevents the mobile electronic device 400 from operating in the first configuration and the second configuration simultaneously.

FIG. 8 shows a section view of the mobile electronic device 400 of FIG. 4 in the normal configuration, illustrating a dual slide mechanism 802 and a flexible circuit 804, in accordance with the first detailed embodiment. The dual slide mechanism 802 includes one or more rods 806, 808, 810, 812 and one or more bushings 814, 816, 818, 820. The dual slide mechanism 802 is coupled to the first housing 102 (not shown in FIG. 8) and the second housing 104 of the mobile electronic device 100. The one or more rods slide within the one or more bushings when the mobile electronic device 400 is switched from one configuration to another to facilitate offsets of the first housing 102 relative to the second housing 104. In accordance with an embodiment, there are two sets of bushings and two sets of rods, for example, a first set of rods 806, 808, a first set of bushings 814, 816, a second set of rods 810, 812, and a second set of bushings 818, 820. The first set of rods 806, 808 performs a reciprocating motion within the first set of bushings 814, 816. The second set of rods 810, 812 performs a reciprocating motion within the second set of bushings 818, 820. The second pin 822 moves in the groove 702 (shown in FIG. 7) and prevents the mobile electronic device 100 from operating in the first configuration and the second configuration simultaneously. In accordance with an embodiment, the flexible circuit 804 is an L-shaped circuit. The flexible circuit 804 provides electrical connections between the first housing 102 and the second housing 104. Examples of the flexible circuit 804 include a flex cable or bundled wires.

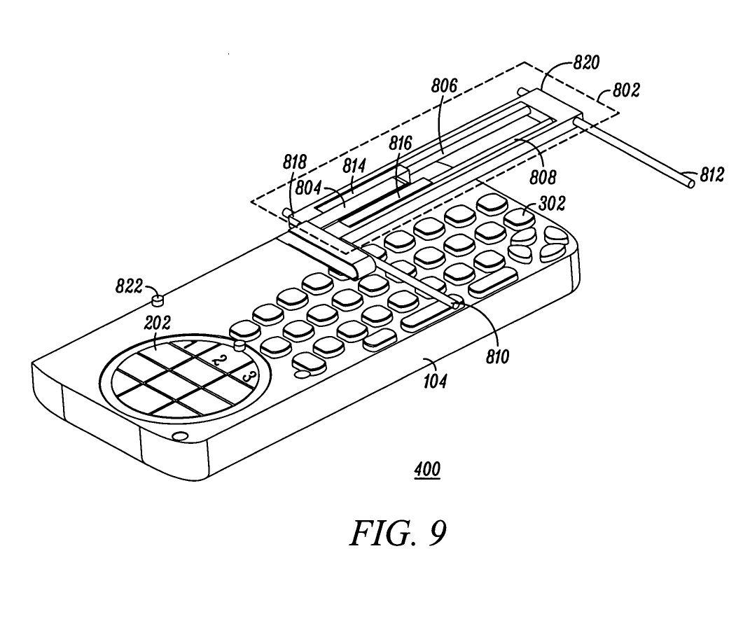

FIG. 9 shows a section view of the mobile electronic device 400 of FIG. 4 in the first configuration illustrating the dual slide mechanism 802 and the flexible circuit 804, in accordance with the first detailed embodiment. The movement of the first set of rods 806, 808, within the first set of bushings 814, 816 allows the mobile electronic device 400 to switch from the normal configuration (as illustrated in FIG. 1) to the first configuration (as illustrated in FIG. 2). Similarly, the movement of the first set of rods 806, 808 through the first set of bushings 814, 816 allows the mobile electronic device 400 to switch from the first configuration (as illustrated in FIG. 9) to the normal configuration (as illustrated in FIG. 8). When switching from the normal configuration to the first configuration and from the first configuration to the normal configuration, the second set of rods 810, 812 does not perform any reciprocating motion within the second set of bushings 818, 820. When the mobile electronic device 400 is switched from the normal configuration (as illustrated in FIG. 8) to the first configuration (as illustrated in FIG. 9), the flexible circuit 804 contracts and retracts along the length of the first housing 102 and the second housing 104, allowing the mobile electronic device 400 to switch to the first configuration while maintaining electrical connections.

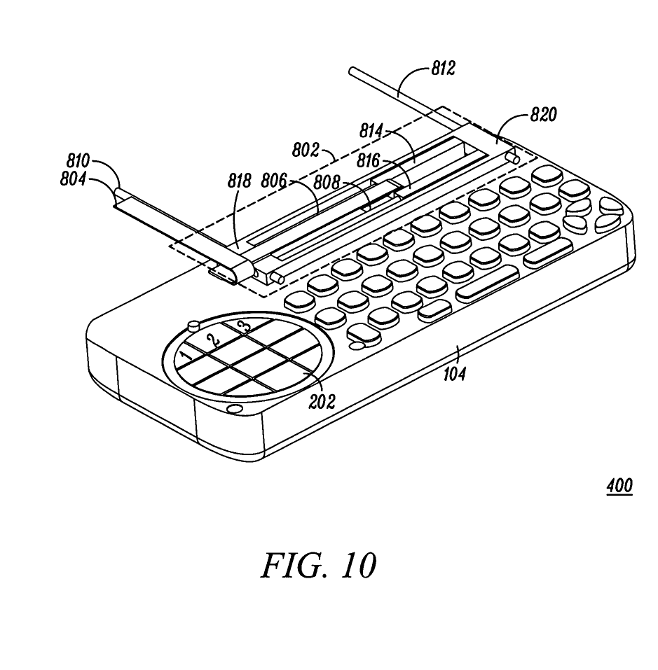

FIG. 10 shows a section view of the mobile electronic device 400 of FIG. 4 in the second configuration, illustrating the dual slide mechanism 802 and the flexible circuit 804, in accordance with the first detailed embodiment. The movement of the second set of rods 810, 812 within the second set of bushings 818, 820 allows the mobile electronic device 400 to switch from the normal configuration (as illustrated in FIG. 1) to the second configuration (as illustrated in FIG. 3). The movement of the second set of rods 810, 812 through the second set of the bushings 818, 820 allows the mobile electronic device 400 to switch from the second configuration (as illustrated in FIG. 10) to the normal configuration (as illustrated in FIG. 8). The first set of rods 806, 808 does not perform any reciprocating motion within the first set of bushings 814, 816 when the mobile electronic device 400 is switched from the normal configuration to the second configuration, and from the second configuration to the normal configuration. Note that the dual slide mechanism 802 does not constrain the first housing 102 from moving both laterally and transversely. Instead, the second pin 822 (see FIGS. 8-9) within the groove 702 (see FIG. 7) is used to prevent diagonal movement of the first housing 102 relative to the second housing 104. If however, diagonal movement is desired, the second pin 822 and the groove 702 can be reconfigured or removed. When the mobile electronic device 400 is switched from the normal configuration (as illustrated in FIG. 8) to the second configuration (as illustrated in FIG. 10), the flexible circuit 804 contracts and retracts along the width of the first housing 102 and the second housing 104, allowing the mobile electronic device 100 to switch to the second configuration while maintaining electrical connections.

In accordance with a second detailed embodiment, the rotatable keypad 202 is rotated by means of a link mechanism. The link mechanism attaches between a dual slide mechanism (such as the dual slide mechanism 802 shown in FIGS. 8-10) and the rotatable keypad 202 and facilitates the rotation of the rotatable keypad 202 when the mobile electronic device 100 is switched from the first to the second configuration, and from the second configuration to the first configuration.

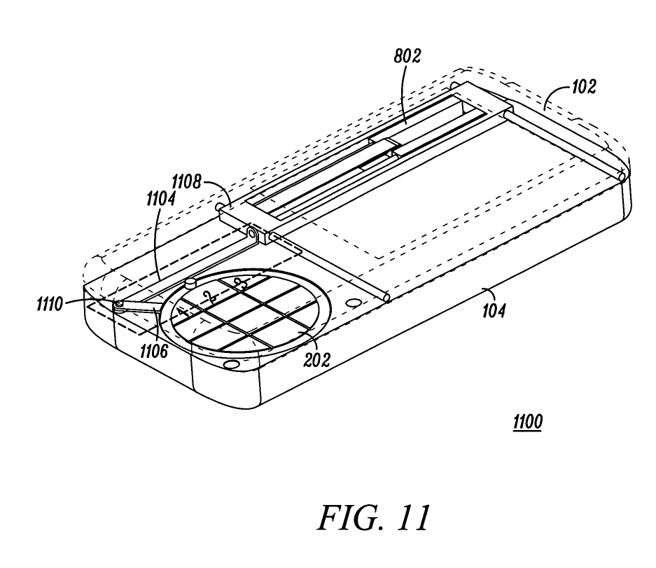

FIG. 11 shows a section view of an exemplary mobile electronic device 1100 in a normal configuration, illustrating rotation of the rotatable keypad 202 using the link mechanism 1102, in accordance with a second detailed embodiment. The link mechanism 1102 includes a first link 1104 and a second link 1106. The first link 1104 is coupled to a bushing 1108 (similar to the bushing 818 shown in FIG. 8) that is a component of a dual slide mechanism 802, which is attached to the first housing 102. The second link 1106 is coupled through an elbow joint 1110 to the first link 1104 and the rotatable keypad 202 in a landscape orientation. The second link 1106 can be formed independently or as a protrusion from the rotatable keypad 202.

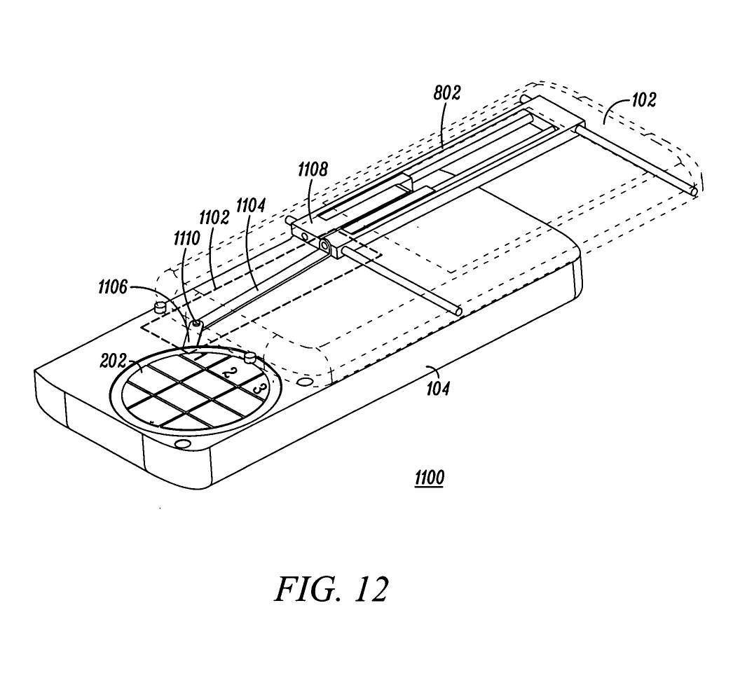

FIG. 12 shows a section view of the mobile electronic device 1100 of FIG. 11 in the first configuration, illustrating rotation of the rotatable keypad 202 using the link mechanism 1102, in accordance with the second detailed embodiment. When the mobile electronic device 1100 is switched from the normal configuration (as illustrated in FIG. 11) to the first configuration (as illustrated in FIG. 12), the first link 1104, which is coupled to the bushing 1108, moves in the direction of the motion of the first housing 102 relative to the second housing 104. This causes the elbow joint 1110 to extend and pull on the second link 1106, which in turn rotates the rotatable keypad 202 to a portrait orientation.

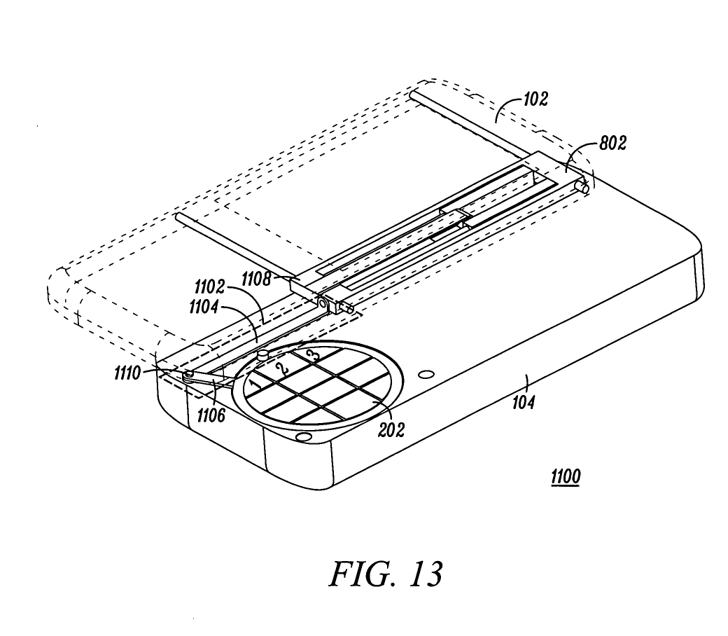

FIG. 13 shows a section view of the mobile electronic device 1100 of FIG. 11 in the second configuration, illustrating rotation of the rotatable keypad 202 using the link mechanism 1102, in accordance with the second detailed embodiment. When the mobile electronic device is switched from the normal configuration (as illustrated in FIG. 11) to the second configuration (as illustrated in FIG. 13), the positions of the first link 1104 and the second link 1106 do not change because there is no change in the position of the bushing 1108, to which the first link 1104 is coupled. Therefore, the position of the rotatable keypad 202 remains in a landscape orientation.

Referring back to FIGS. 1-3, in accordance with a third detailed embodiment, the rotatable keypad 202 is rotated using a stepper motor and one or more sensors. The stepper motor and the one or more sensors are located in the second housing 104. The one or more magnets 204 are implemented as Hall effect sensors and used to regulate the rotation of the stepper motor. The stepper motor is coupled to the rotatable keypad 202, and facilitates the rotation of the rotatable keypad 202 when the mobile electronic device is switched from the first configuration to the second configuration, and from the second configuration to the first configuration. As stated previously, the one or magnets 204 can be located in alternate or additional locations on the mobile electronic device 100.

Referring back to FIGS. 1-3, in accordance with a fourth detailed embodiment, the mobile electronic device 100 is a portable electronic device including the first housing 102 and the second housing 104. The second housing 104 includes the rotatable keypad 202 that rotates when the first housing 102 and the second housing 104 are moved to a first configuration from a most compact configuration. The first housing 102 includes a display, which changes orientation when the first housing 102 and the second housing 104 are moved to the first configuration from the most compact configuration.

Various embodiments of the present invention, as described above, provide a mobile electronic device suitable for operation in a normal configuration, first configuration, and a second configuration. The rotation of a rotatable keypad present in the mobile electronic device makes the mobile electronic device more user friendly when the mobile electronic device is operated in the first configuration and the second configuration. The mobile electronic device has two housings, a first housing and a second housing, thus making it compact with increased display area. The presence of the rotatable number keypad and set of alphabet keys in the second housing makes the typing of a text containing both alphabet and number characters easier.

It will be appreciated the mobile electronic device described herein may include of one or more conventional processors and unique stored program instructions that control the one or more processors to implement, in conjunction with certain non-processor circuits, some of the functions of the mobile electronic device described herein. The non-processor circuits may include, but are not limited to, a radio receiver, a radio transmitter, signal drivers, clock circuits, power source circuits, and user input devices.

It is expected that one of ordinary skill, notwithstanding possibly significant effort and many design choices motivated by, for example, available time, current technology, and economic considerations, when guided by the concepts and principles disclosed herein will be readily capable of manufacturing a device in accordance with the description as set out above.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” or “comprising . . . a”, does not, without more constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An mobile electronic device suitable for operation in a first configuration and a second configuration, the mobile electronic device comprising:
a first housing moveable between a first configuration position and a second configuration position; and
a second housing coupled to the first housing, the second housing comprising a rotatable keypad, wherein the rotatable keypad is mechanically coupled to the first housing such that the rotatable keypad rotates when the mobile electronic device is switched from the first configuration to the second configuration.

2. The mobile electronic device according to claim 1 wherein the first housing is offset from the second housing in one direction in the first configuration and offset from the second housing in another direction in the second configuration.

3. The mobile electronic device according to claim 1 wherein the rotatable keypad rotates when the mobile electronic device is switched from the second configuration to the first configuration.

4. The mobile electronic device according to claim 1 wherein the first housing comprises a display unit.

5. The mobile electronic device according to claim 1 wherein the first housing comprises external keys.

6. The mobile electronic device according to claim 5 wherein the external keys are navigation keys.

7. The mobile electronic device according to claim 5 wherein the external keys are implemented virtually.

8. The mobile electronic device according to claim 1 wherein the second housing further comprises a set of keys.

9. The mobile electronic device according to claim 1 wherein the first housing comprises a slot, the slot facilitating rotation of the rotatable keypad by guiding movement of a first pin in the slot, the first pin being located on the rotatable keypad.

10. The mobile electronic device according to claim 1 further comprising a link mechanism, the link mechanism comprising:
a first link coupled to the first housing;
an elbow joint couple to the first link; and
a second link coupled to the elbow joint and the rotatable keypad,
wherein the link mechanism facilitates rotation of the rotatable keypad.

11. The mobile electronic device according to claim 1 further comprising one or more magnets.

12. The mobile electronic device according to claim 1 further comprising one or more sensors.

13. The mobile electronic device according to claim 1 further comprising a stepper motor, the stepper motor facilitating rotation of the rotatable keypad.

14. The mobile electronic device according to claim 1 further comprising a groove for allowing a second pin to move inside the groove, the groove being located on one of the first housing and the second housing, and the second pin being located on another of the first housing and the second housing, the second pin preventing the mobile electronic device from operating in the first configuration and the second configuration simultaneously.

15. The mobile electronic device according to claim 1 further comprising a dual slide mechanism, the dual slide mechanism comprising:
one or more bushings; and
one or more rods for sliding within the one or more bushings,
wherein the dual slide mechanism facilitates switching of the mobile electronic device between the first configuration and the second configuration.

16. The mobile electronic device according to claim 1 further comprising a flexible circuit wherein the flexible circuit provides electrical connections between the first housing and the second housing.

17. The mobile electronic device according to claim 1 wherein the rotatable keypad comprises at least 12 keys.

18. A portable electronic device comprising:
a first housing moveable between a most compact configuration position and a less compact configuration position; and
a second housing coupled to the first housing, the second housing comprising a rotatable keypad that is mechanically coupled to the first housing such that the rotatable keypad rotates when the first housing is moved to the less compact configuration position from the most compact configuration position.

19. The portable electronic device according to claim 18 wherein the first housing comprises a display.

20. The portable electronic device according to claim 19 wherein the display changes orientation when the first housing is moved to the less compact configuration position from the most compact configuration position.
